(19) United States
(12) Patent Application Publication
(10) Pub. No.: US 2016/0165841 A1
(43) Pub. Date: Jun. 16, 2016

(54) Animal Watering Apparatus

(71) Applicant: Banks Outdoors Corporation, Cannon Falls, MN (US)

(72) Inventor: Robert S. Banks, Cannon Falls, MN (US)

(21) Appl. No.: 14/571,558

(22) Filed: Dec. 16, 2014

(51) Int. Cl. A01K 7/02

(52) U.S. Cl. CPC A01K 7/02

(57) ABSTRACT

An animal water holding tank and trough is described, that allows multiple animals to drink from opposite sides of the tank simultaneously. The tank and trough interconnect together and water is gravity fed to the trough without requiring a shutoff float. The trough may be positioned under the tank to extend out opposite sides of the tank or just one side of the tank.

### CROSS-REFERENCE TO RELATED APPLICATIONS

Not Applicable

### FEDERAL SPONSORSHIP

Not Applicable

### JOINT RESEARCH AGREEMENT

Not Applicable

### TECHNICAL FIELD

This invention pertains generally to gravity fed water tanks. More particularly, the invention pertains to a gravity fed water tank having an adjustable water trough extending from one or both sides of the water tank.

### BACKGROUND

Both wild animals and domesticated livestock need a dependable source of water to survive. Oftentimes there is a need to complement natural, uncontaminated drinking water sources with water tanks and water troughs filled from water sources inaccessible to wild animals or livestock. Also, scarce water sources for animals in various regions and geographic locations require supplemented water sources to keep the animals from ranging away from sparse water locales. And, with the continued encroachment on natural habitat and development of regular range land, it has become increasingly difficult to interest certain wild animals to utilize preferred acreages without providing a viable uncontaminated drinking water source. Further, in drier climates it may be desirable to provide an easily transportable and re-locatable water source to avoid over use of land adjacent the water source.

Although ground tanks and troughs may be desirable to provide a water source to a variety of animals, open access to voids under the tank may also provide suitable habitat for unwanted reptiles. Elevating the tank or trough above the ground may eliminate habitat for reptiles, however, an elevated trough or tank may be difficult for some animals to utilize the water source.

### SUMMARY

Embodiments according to aspects of the invention are capable of providing a suitable portable alternative ground water source. Further embodiments according to aspects of the invention are capable of providing a ground supported water tank that includes sidewall openings to allow a trough to slide between the openings while obstructing reptiles from accessing the underside of the tank.

An embodiment according to aspects of the invention includes a tank having an enclosed top and bottom with a continuous sidewall interconnecting the top and bottom. A fluid inlet is formed in the enclosed top and a fluid outlet is formed in a lower bottom portion of the tank. The continuous sidewall extends downward from the bottom of the tank beyond a perimeter of the enclosed bottom. Two opposed openings are formed in the lower portion of the sidewall and the openings extend through the sidewall below the enclosed bottom of the tank. A water trough may be positioned to extend through the opposed sidewall openings. A trough stop extends downward from the enclosed bottom and restricts an end of the trough from being pulled under the tank. The fluid inlet includes a removable plug of known suitable construction that seals to the fluid inlet. A shaw plug is one such suitable plug that includes a lever to efficiently disengage the plug from the fluid inlet. The fluid outlet is positioned in a lower bottom portion of the tank and includes a threaded orifice. A drain or flow control valve may be coupled to the threaded orifice to allow a user to control the flow of fluid out of the fluid outlet.

In use, a trough may be dimensioned and aligned to extend through the two opposed openings of the continuous sidewall in a manner that the trough may slide through the openings while obstructing the openings and restricting access into an interior region formed by said continuous sidewall. When a plug is sealed in the fluid inlet, water flows into the trough from the fluid outlet of the tank into the trough until the water level in the trough reaches the horizontal level of the fluid outlet. The gravity fed flow of water reaches an equilibrium and stops flowing when the water height in the trough is level with the fluid outlet. The user may selectively slide the trough through the openings so that the trough only extends from one side of the trough or both sides of the trough. When the trough is being slid through the openings, a trough stop extending from the bottom of the tank or the fluid outlet will engage an end of the trough so that the trough end is stopped flush with an adjacent outer sidewall. When the tank is full of water, a top edge of the trough may engage the sidewall opening to provide further support and stability to the tank.

An embodiment according to aspects of the invention includes a tank and a trough slidingly engaged with the tank. The tank includes an enclosed top and bottom with a continuous sidewall interconnecting the top and bottom. A fluid inlet is formed in the enclosed top and a fluid outlet is formed in the enclosed bottom portion of the tank. A removable plug creates a water tight seal in the fluid inlet. The fluid outlet includes a drain that controls the rate of flow of fluid from the fluid outlet. The continuous sidewall extends downward from the bottom of the tank beyond a perimeter of the enclosed bottom. The sidewall includes first and second opposed openings extending through the sidewall below the enclosed bottom of the tank. The trough extends through the two opposed openings of the continuous sidewall in a manner that the trough obstructs access through the openings into an interior region below the bottom of the tank formed by the continuous sidewall. The tank may further include a trough stop extending downward from the enclosed bottom of the tank. The trough stop is positioned or aligned on the enclosed bottom proximate to the first opening, wherein the trough slides through the first opening and the trough stop restricts an end of the trough from sliding inward past the first openings. The fluid outlet may further include a threaded orifice to which the drain is coupled. The drain may be a restricted opening, for example, or may include an actuable flow control valve that actuates between a fluid flow open and closed position.

The accompanying drawings, which are incorporated in and constitute a portion of this specification, illustrate embodiments of the invention and, together with the detailed description, serve to further explain the invention. The embodiments illustrated herein are presently preferred; however, it should be understood, that the invention is not limited to the precise arrangements and instrumentalities shown. For a fuller understanding of the nature and advantages of the invention, reference should be made to the detailed description in conjunction with the accompanying drawings.

### DESCRIPTION OF THE DRAWINGS

In the various figures, which are not necessarily drawn to scale, like numerals throughout the figures identify substantially similar components.

FIG. 1 is a top perspective view of an embodiment of an animal watering apparatus of the present invention;

FIG. 2 is a front perspective view of an embodiment of an animal watering apparatus of the present invention;

FIG. 3 is a back perspective view of the animal watering apparatus of the present invention of the type shown in FIG. 2;

FIG. 4 is a bottom perspective view of an embodiment of an animal watering apparatus of the present invention;

FIG. 5 is a bottom perspective view of an embodiment of an animal watering apparatus of the present invention;

FIG. 6 is a bottom side perspective view of an embodiment of the animal watering apparatus of the present invention;

FIG. 7 is a bottom perspective view of an embodiment of the animal watering apparatus of the present invention;

FIG. 8 is a bottom perspective view of an embodiment of the animal watering apparatus of the present invention;

FIG. 9 is a top perspective view of an embodiment of the animal watering apparatus of the present invention;

FIG. 10 is a top perspective view of an embodiment of the animal watering apparatus of the present invention;

FIG. 11 is a top plan view of the animal watering apparatus of the type shown in FIG. 10;

FIG. 12 is a side view of the animal watering apparatus of the type shown in FIG. 10;

FIG. 13 is an opposing side view of the animal watering apparatus of the type shown in FIG. 12;

FIG. 14 is a front view of the animal watering apparatus of the type shown in FIG. 10;

FIG. 15 is a back view of the animal watering apparatus of the type shown in FIG. 10;

FIG. 16 is a bottom plan view of the animal watering apparatus of the type shown in FIG. 10;

FIG. 17 is a top front perspective view of an embodiment of the animal watering apparatus of the present invention;

FIG. 18 is a bottom back perspective view of the animal watering apparatus of the type shown in FIG. 17;

FIG. 19 is a top plan view of the animal watering apparatus of the type shown in FIG. 17;

FIG. 20 is a side view of the animal watering apparatus of the type shown in FIG. 17;

FIG. 21 is an opposing side view of the animal watering apparatus of the type shown in FIG. 20;

FIG. 22 is a front view of the animal watering apparatus of the type shown in FIG. 17;

FIG. 23 is a back view of the animal watering apparatus of the type shown in FIG. 17; and

FIG. 24 is a bottom plan view of the animal watering apparatus of the type shown in FIG. 17.

### DETAILED DESCRIPTION

The following description provides detail of various embodiments of the invention, one or more examples of which are set forth below. Each of these embodiments are provided by way of explanation of the invention, and not intended to be a limitation of the invention. Further, those skilled in the art will appreciate that various modifications and variations may be made in the present invention without departing from the scope or spirit of the invention. By way of example, those skilled in the art will recognize that features illustrated or described as part of one embodiment, may be used in another embodiment to yield a still further embodiment. Thus, it is intended that the present invention also cover such modifications and variations that come within the scope of the appended claims and their equivalents.

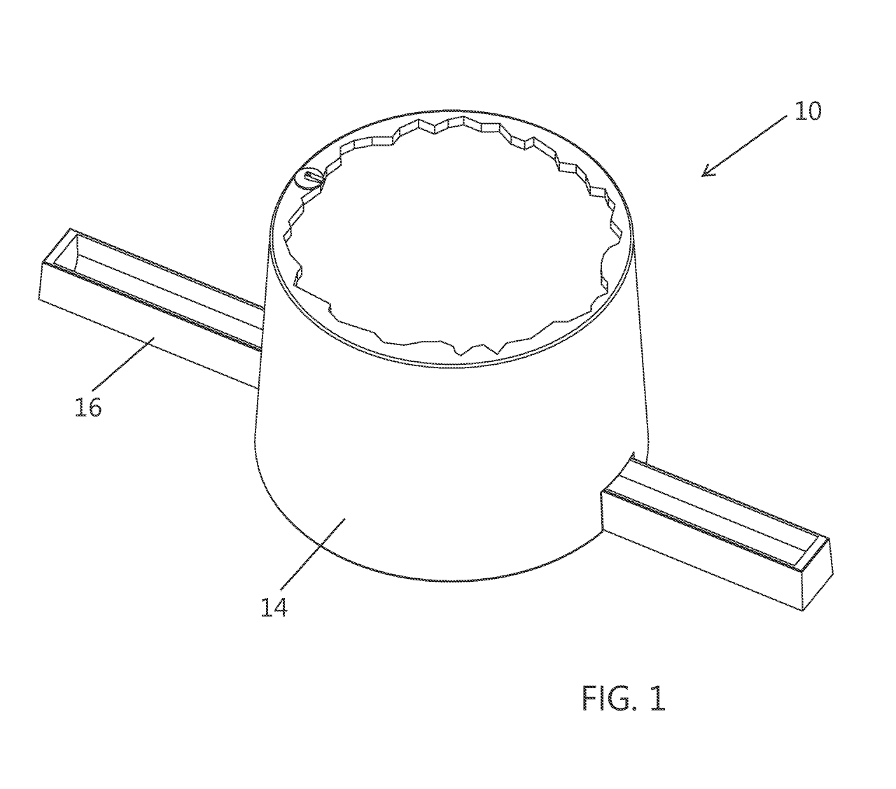

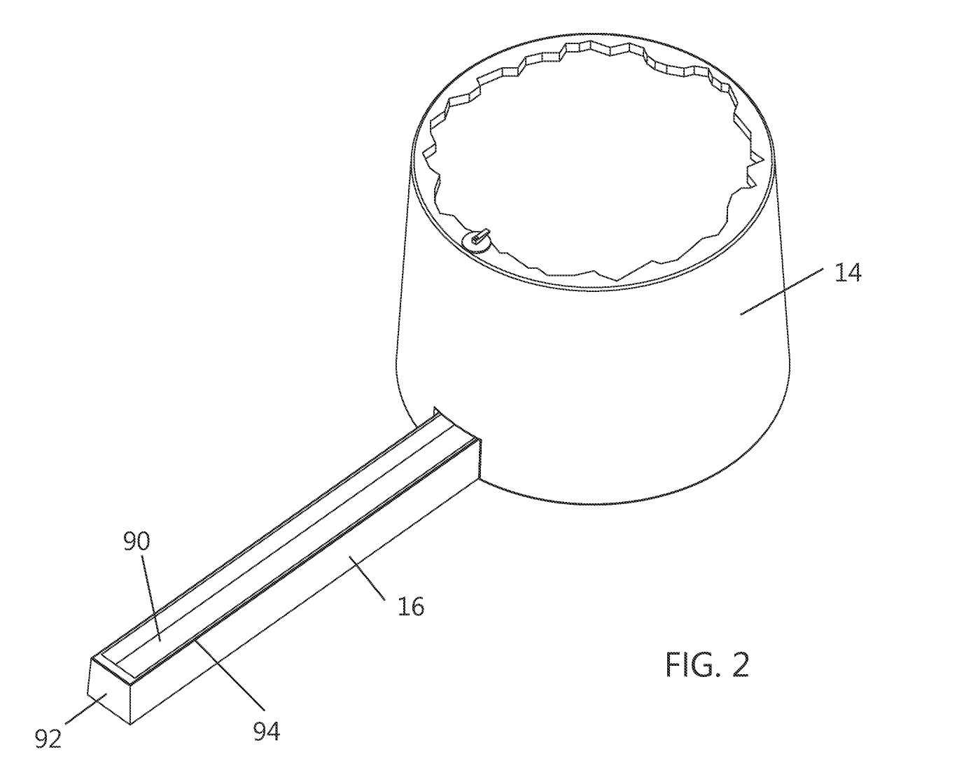

The apparatus 10 of the present invention is particularly well suited for providing an alternative uncontaminated water source for animals. In an embodiment of the invention the apparatus includes water tank 14 and trough 16. As illustrated in FIGS. 1-3 the trough 16 includes water tray 90, ends 92 and top edge 94. The outside edges of the trough 16 and inner edges of water tray 90 may include rounded corners and edges 96. Tank 14 includes an enclosed top 30 and enclosed bottom 32 that are separated by a continuous sidewall 34. Enclosed top 30 includes a top rim 36 that extends about the perimeter of the top 30. The rim includes a hole 38 extending through the rim and into a hollow center portion of tank 14. A shaw plug 40 of suitable known construction engages with hole 38. The shaw plug 40 includes a lever 42 that pivots between an open and closed position. When in a closed position, an external diameter increases from a diameter when the lever is in an open position. The shaw plug 40 is sized so that when the lever 42 is in the closed position the external cylindrical wall of the shaw plug engages with the sides of the hole with enough force that air does not escape between the shaw plug 40 and hole 38. The rim 36 further includes an ornamental edge recessed into the enclosed top 30.

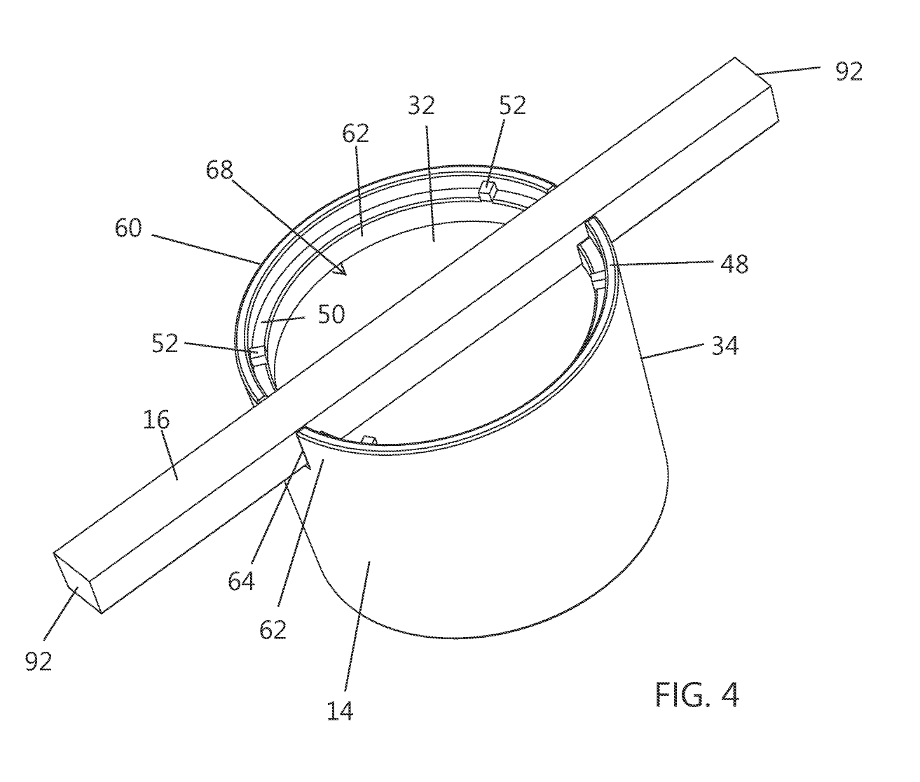

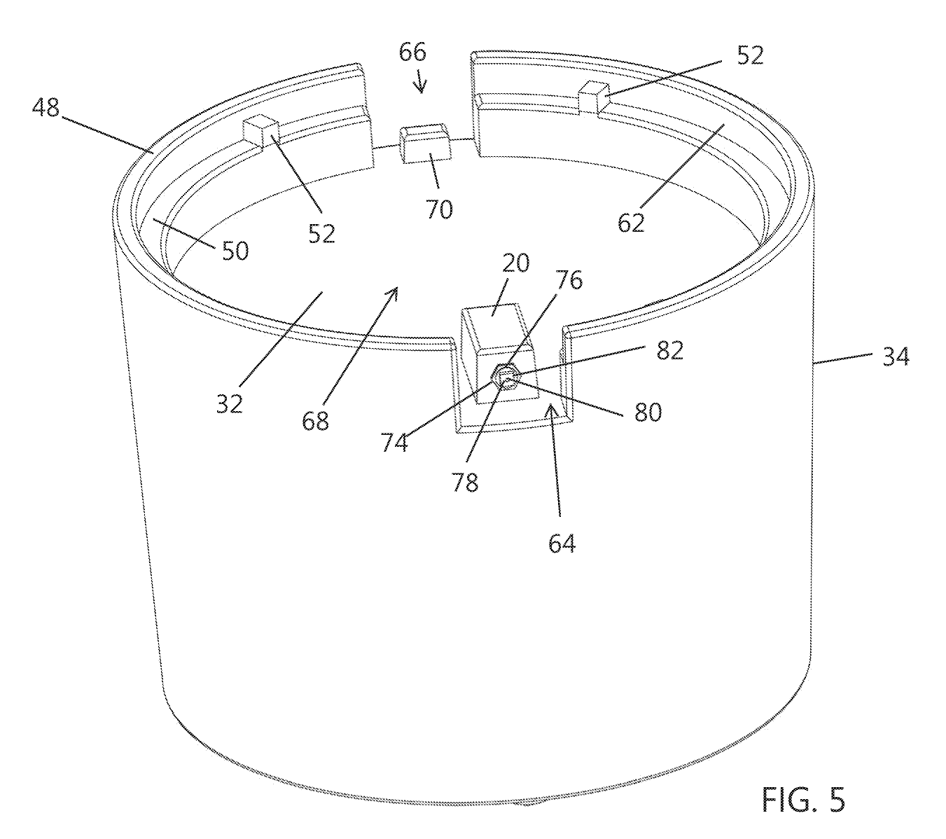

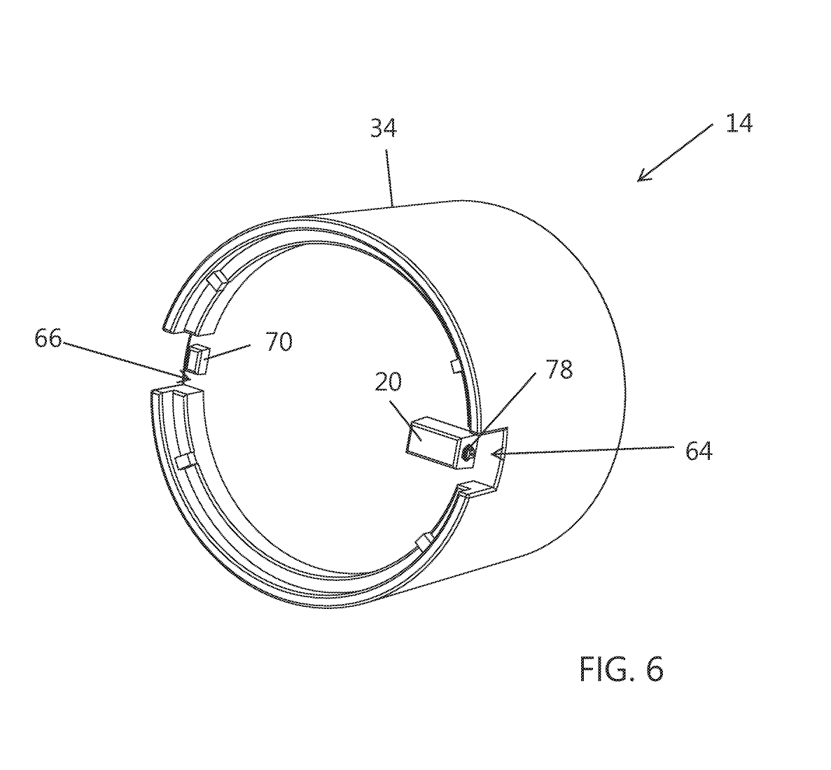

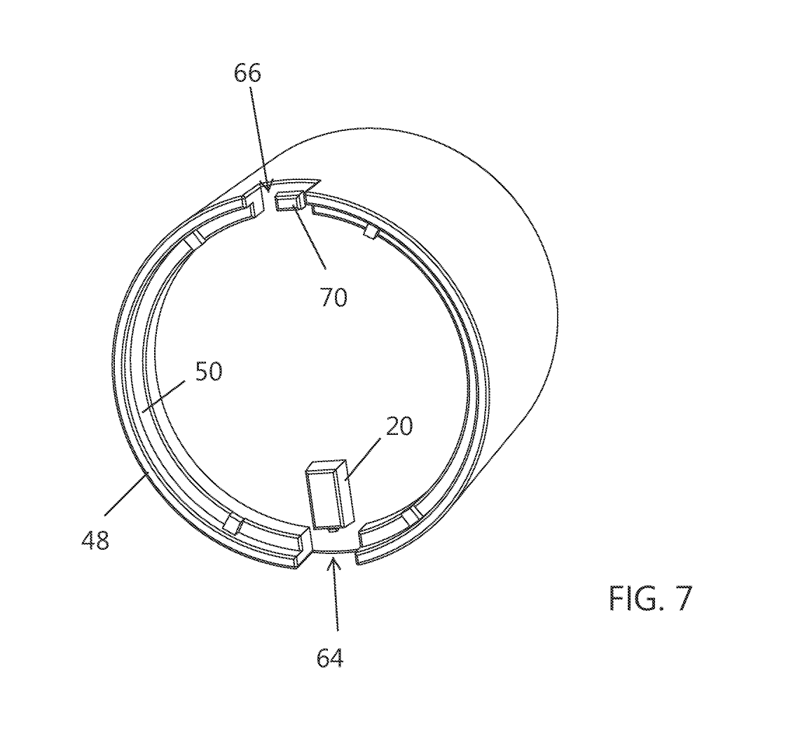

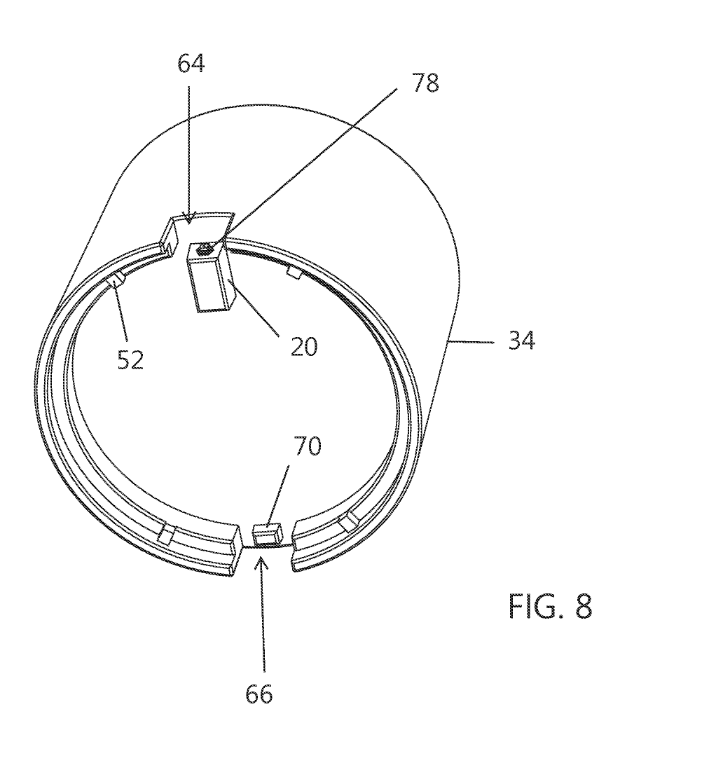

FIGS. 4-9 further illustrates features of the tank 14 of the present invention. Continuous sidewall 34 extends downward forming an extended sidewall 62 which extends from a perimeter 60 of the enclosed bottom 32 terminating in a bottom rim 48. The bottom rim 48 includes an inner concentric ledge 50. Pads 52 extend from ledge 50 and are suitable to engage with the top rim 36 and perimeter edge 58 of another tank on which it may be stacked. First opening 64 and second opening 66 are formed in the extended sidewall 62 and are sized and shaped to conform with an external shape of trough 16. Interior region 68 is defined by enclosed bottom 32 and extended sidewall 62. Within the interior 68 and aligned with first opening 64 is drain 72 integrated with fluid outlet 20. The drain 72 may, by way of example, include a hex insert 74 molded congruent with the tank 14. A round threaded hole 76 is formed in the hex insert 74. The threaded hole 74 is adapted to receive drain plug 78 having an orifice 80 extending therethrough. The diameter of the orifice may be increased or decreased to control the rate of fluid draining out of the tank 14 through the drain 72 and orifice 80. The plug 78 may include a shape 82 such as a square to provide a gripping shape for a tool to rotate and tighten the plug 78 within the hole 76. Alternatively, a faucet or valve may be coupled to the threaded hole 74. The outer hex portion of insert 74 embeds within the sidewall so that when plug 78 or a faucet is tightened within the threaded hole 76 the insert does not rotate within the sidewall.

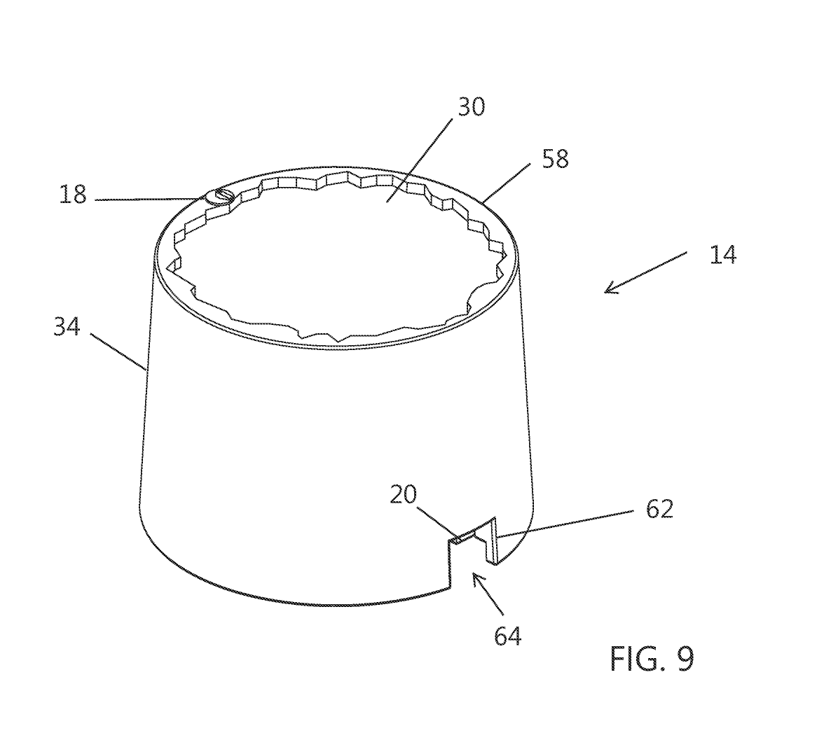

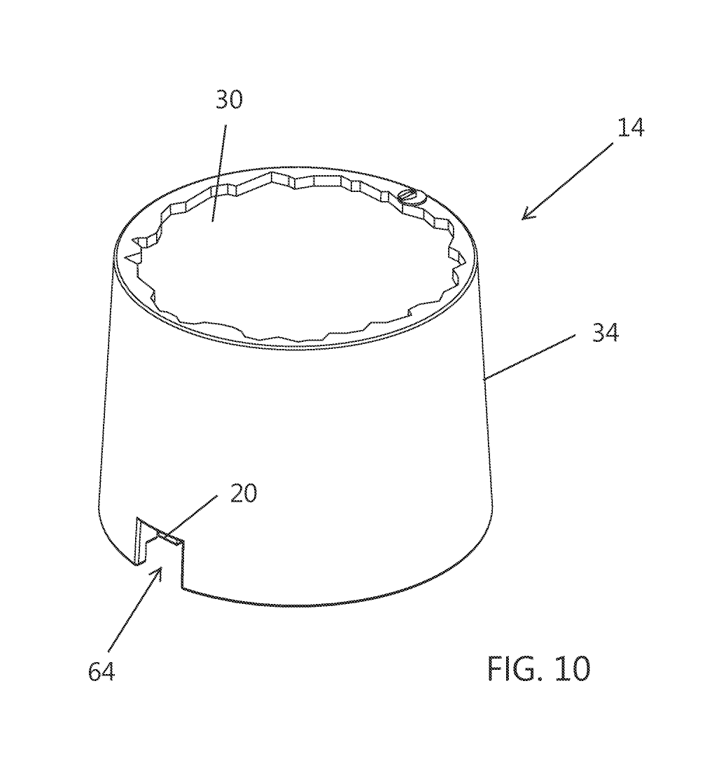

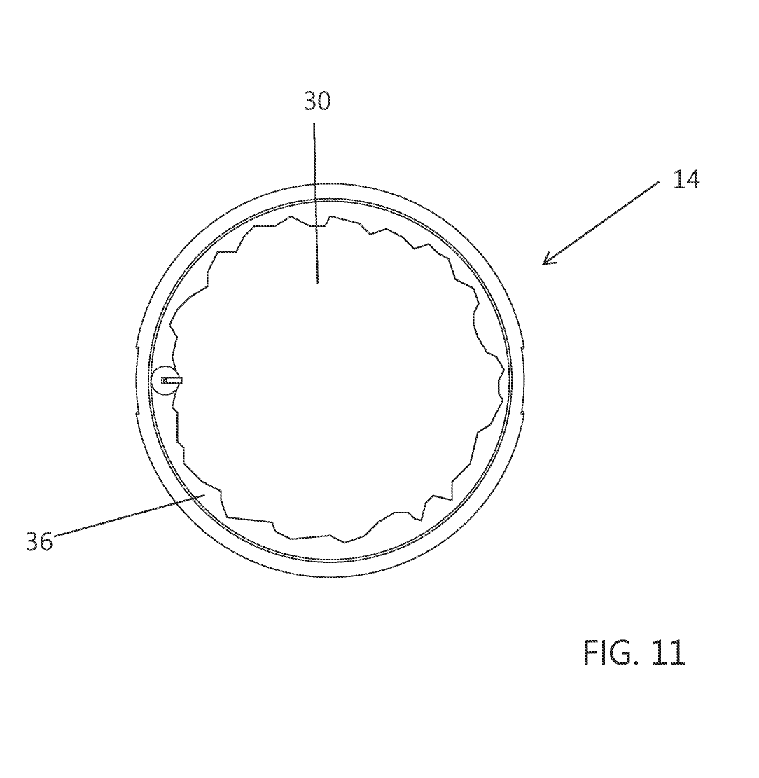

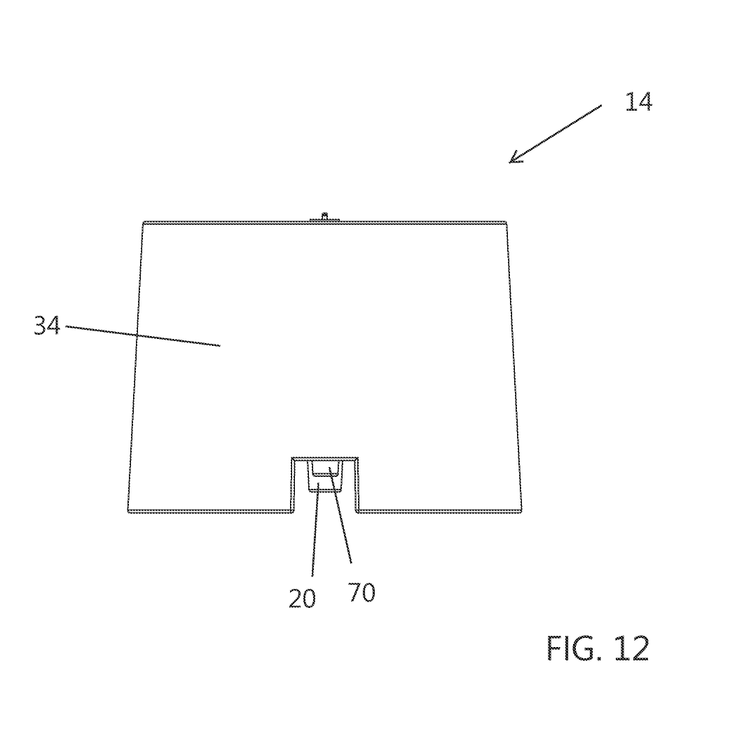

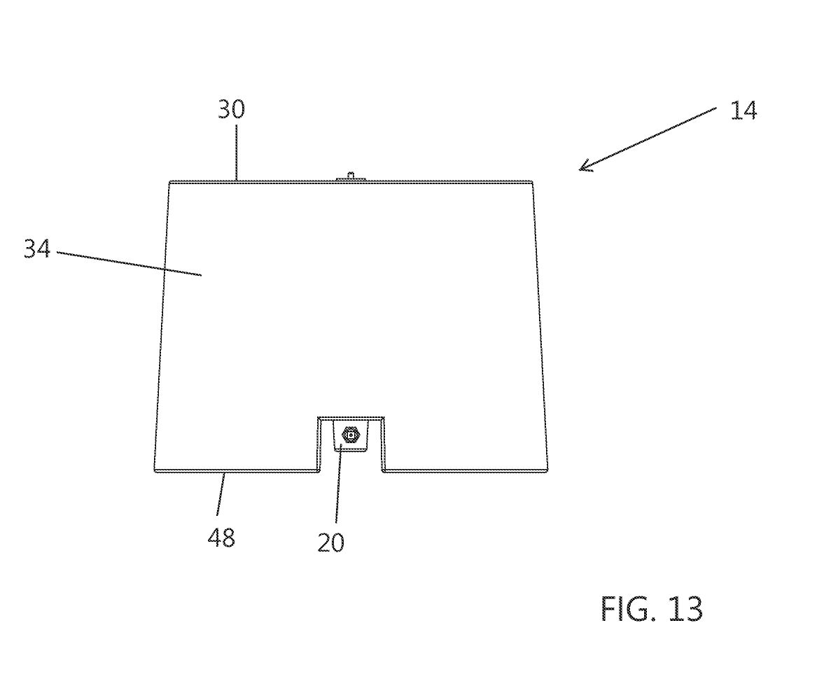

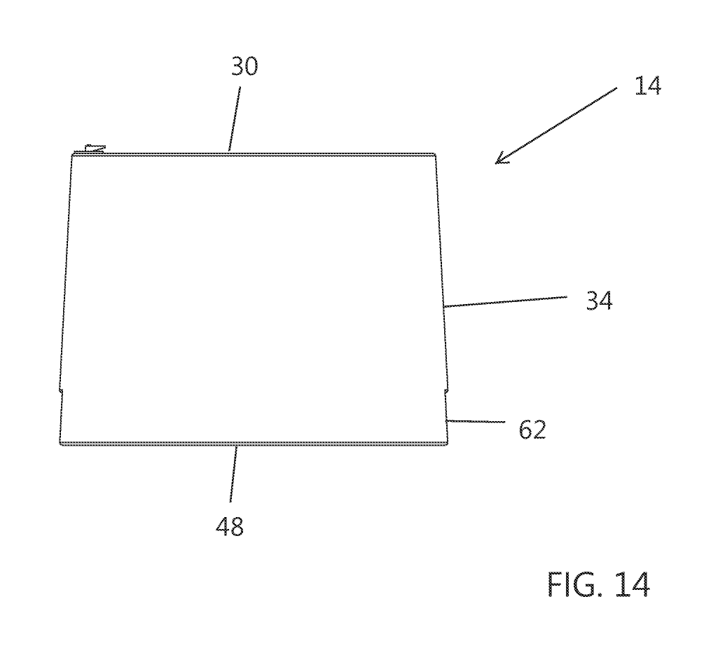

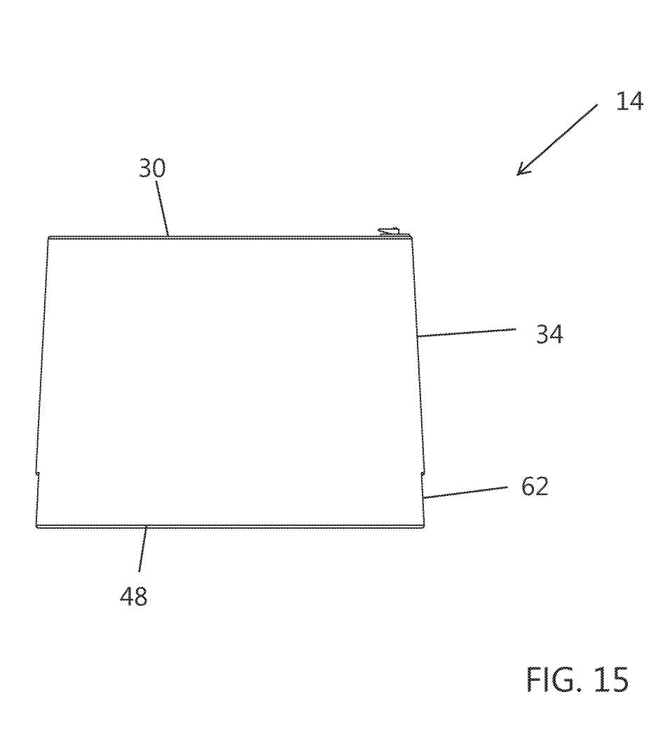

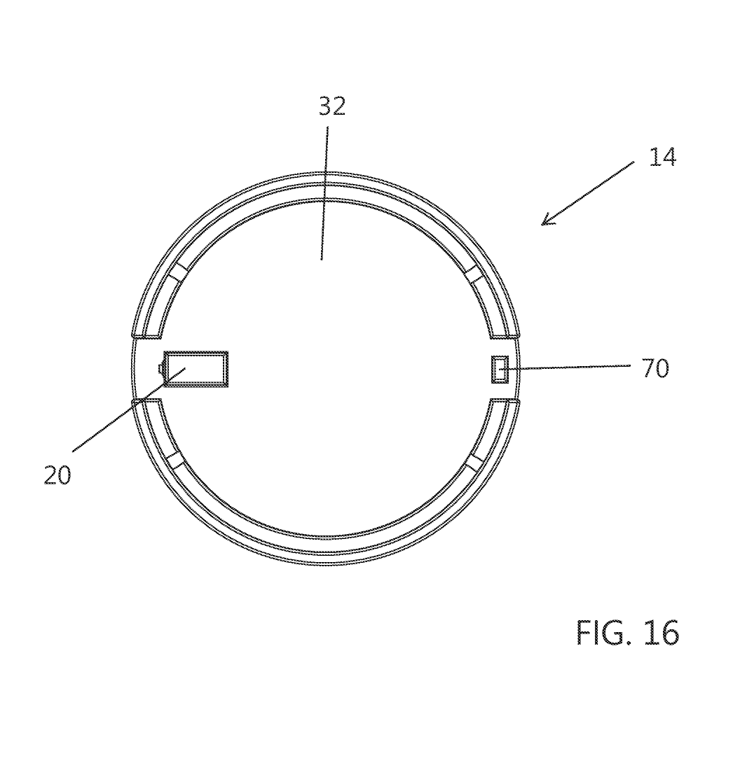

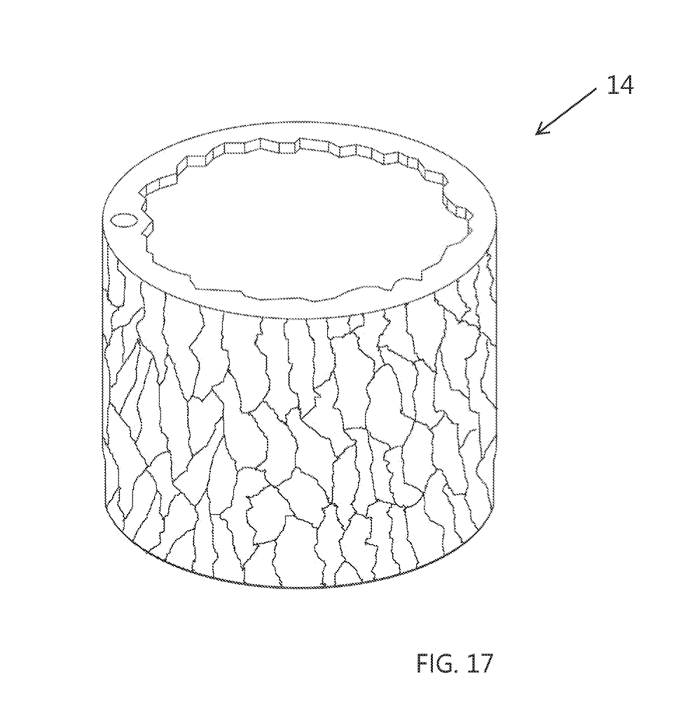

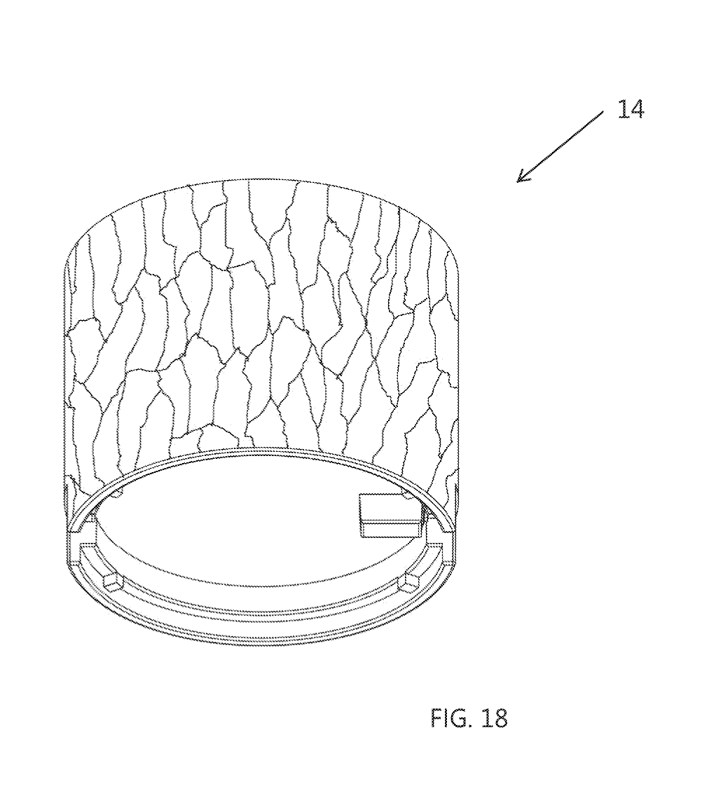

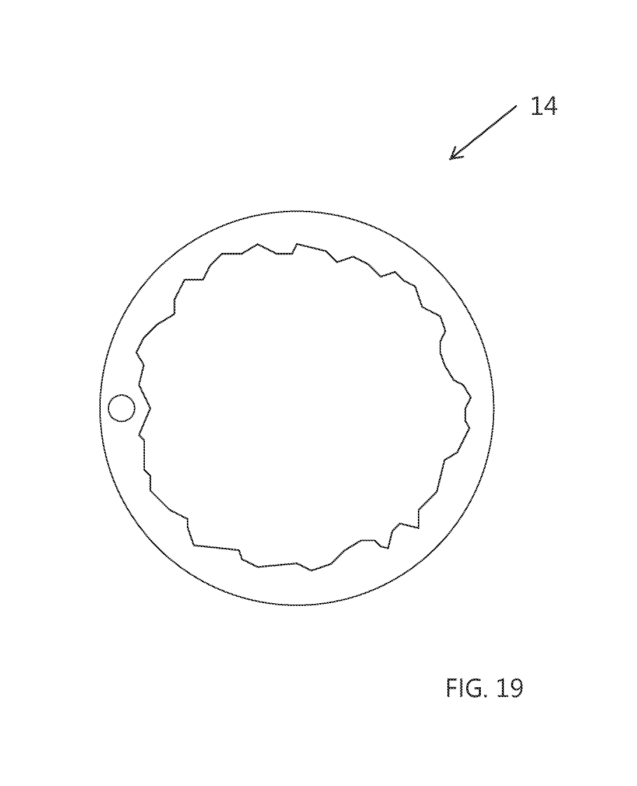

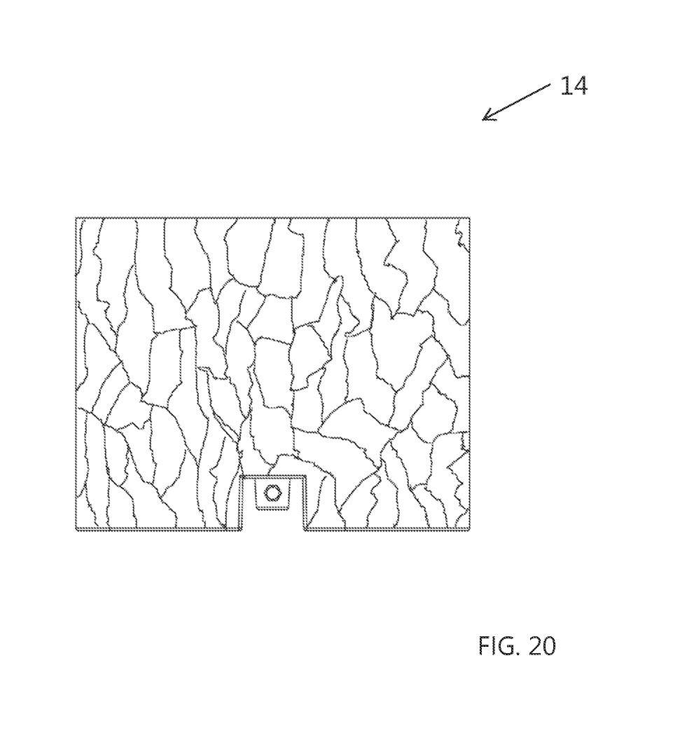

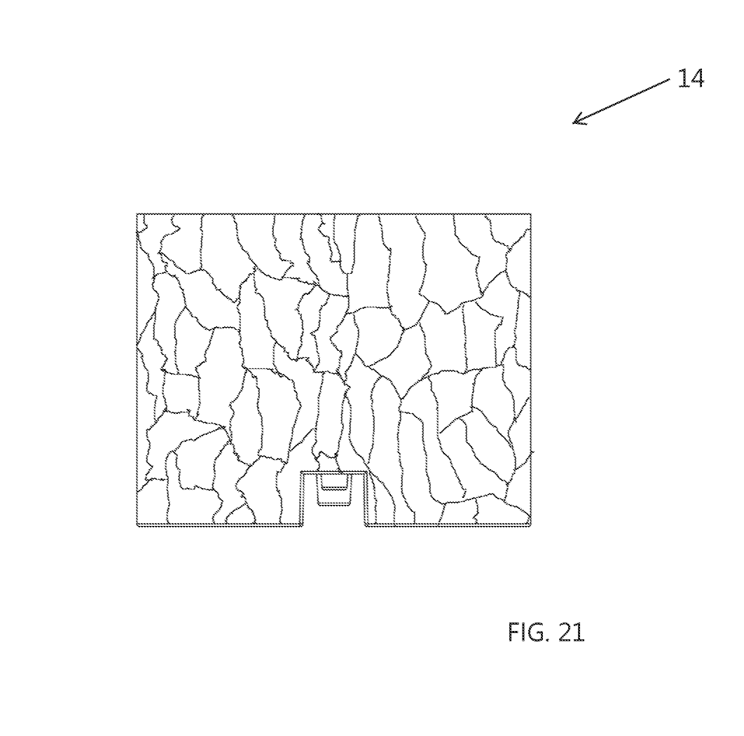

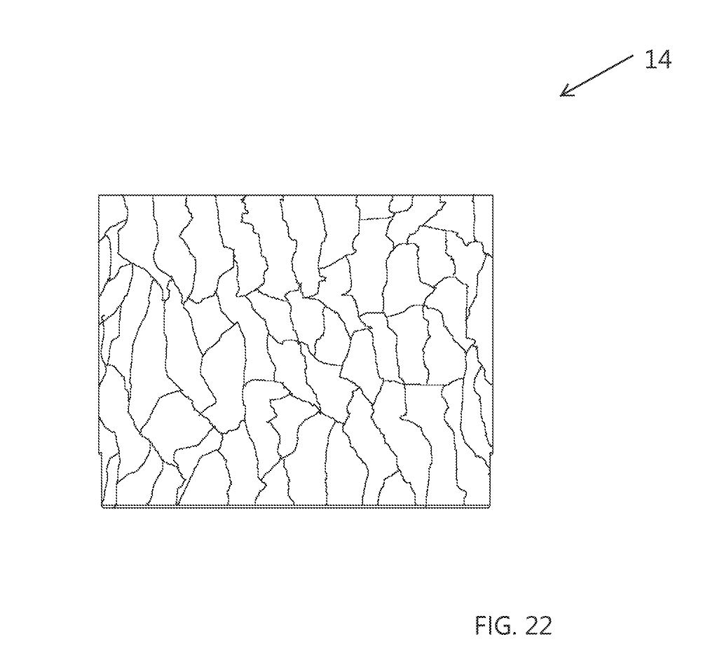

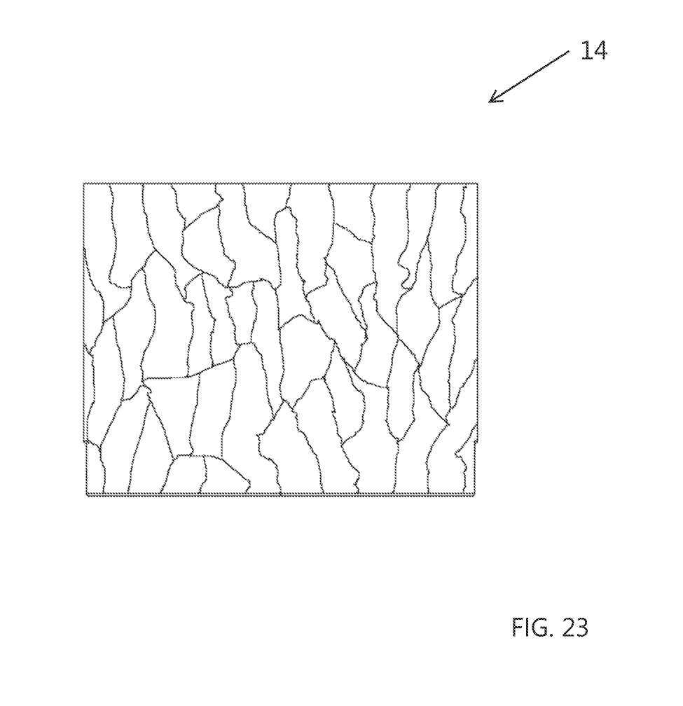

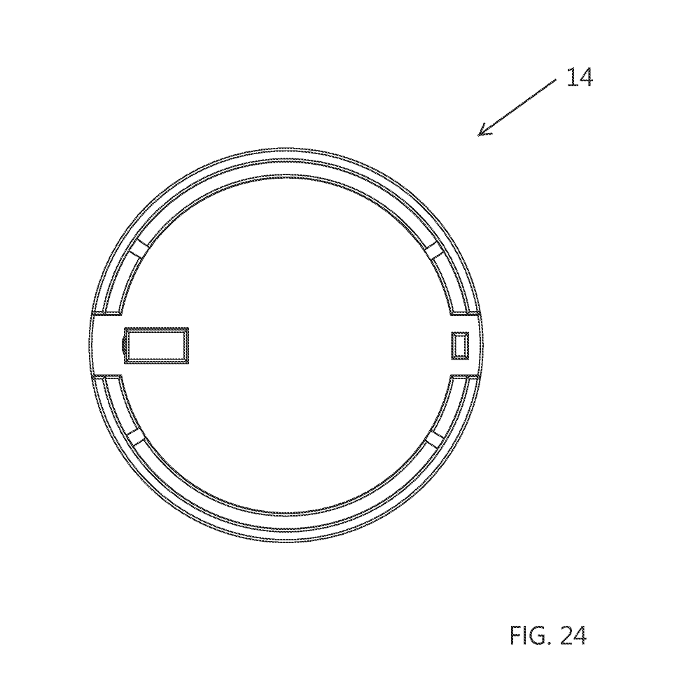

Those skilled in the art will appreciate that the tank 14 and trough 16 may be constructed from a variety of materials including a roto moldable food grade resin to avoid toxins from leaking into the water contained within the tank or trough. Further the exterior of the tank 14 and/or trough 16 may be colored, textured 24, and include an ornamental look and feel to blend into a natural surroundings. FIGS. 9-24 illustrate embodiments of tank 14 that includes an ornamental design. Having described the construction and ornamental features of the present invention, the mode of use will now be presented. In use, trough 14 is positioned on the ground over tray 16 extending through the two opposed openings 64 and 66 of the continuous sidewall 34 of the tank. The trough 16 may slide from side to side through the openings 64 and 66. The outer sides of trough 16 may be sized to obstruct the openings and restricting access into an interior region formed by the extended sidewall 62. Fluid outlet drain 72 is aligned with opening 64 allowing a user to access the drain and interchange a drain plug 78 or valve without disengaging the tank from the trough 16.

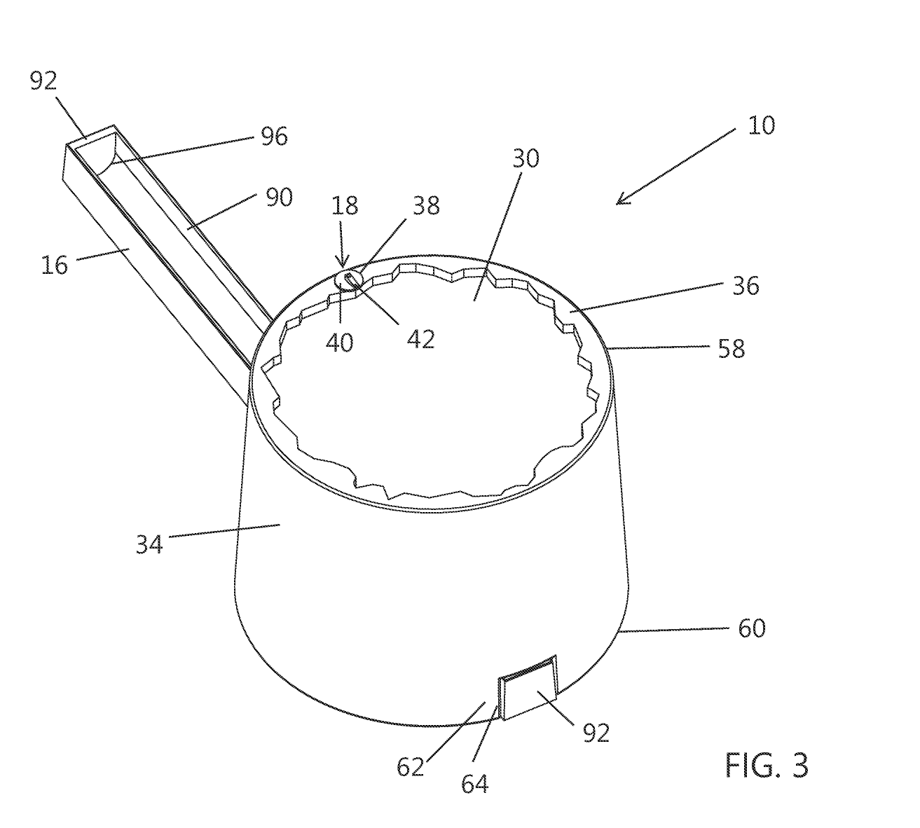

When a plug 78 is sealed in the fluid inlet, water flows into the trough through orifice 80 until a water level in the trough reaches the height of the orifice 80. The flow of water out of the tank reaches an equilibrium and stops flowing when the water height in the trough is level with the orifice (so long as the plug 40 is sealed in the fluid inlet 18). The user may selectively slide the trough 16 through the openings 64 and 66 so that the trough only extends from one side of the trough or both sides of the trough. When the trough is being slid through the openings, trough stop 70 engages with an end 92 of the trough 16 so that the trough end aligns flush with an adjacent outer sidewall of the tank (see FIG. 3). When the tank 14 is full of water, a top edge of the trough may engage the sidewall opening to provide further support and stability to the tank. To refill the tank, the user removes plug 40 and directs fluid into the fluid inlet 18. Those skilled in the art will appreciate that a second tank 14 may be transported on a motorized vehicle and used to fill a partially empty first tank located in the field.

These and various other aspects and features of the invention are described with the intent to be illustrative, and not restrictive. This invention has been described herein with detail in order to comply with the patent statutes and to provide those skilled in the art with information needed to apply the novel principles and to construct and use such specialized components as are required. It is to be understood, however, that the invention can be carried out by specifically different constructions, and that various modifications, both as to the construction and operating procedures, can be accomplished without departing from the scope of the invention. Further, in the appended claims, the transitional terms comprising and including are used in the open ended sense in that elements in addition to those enumerated may also be present. Other examples will be apparent to those of skill in the art upon reviewing this document.

What is claimed is:

1. An animal watering apparatus comprising:
a tank having an enclosed top and bottom with a continuous sidewall interconnecting the top and bottom; a fluid inlet is formed in said enclosed top and a fluid outlet is formed in a lower bottom portion of said tank;
said continuous sidewall extending downward from said bottom of said tank beyond a perimeter of said enclosed bottom, said sidewall including two opposed openings extending through the sidewall below the enclosed bottom of the tank.

2. The apparatus as recited in claim 1 further including a trough extending through the two opposed openings of said continuous sidewall, wherein the trough obstructs the openings of said continuous sidewalls and restricts access into an interior region formed by said continuous sidewall.

3. The apparatus as recited in claim 2, further including a trough stop extending downward from said enclosed bottom.

4. The apparatus as recited in claim 1, wherein said trough is slidingly engaged to the openings of said continuous sidewall.

5. The apparatus as recited in claim 2, wherein said trough stop is positioned on said enclosed bottom proximate to a first of said openings, wherein said trough slides through said first opening and said trough stop restricts an end of said trough from sliding past said opening.

6. The apparatus as recited in claim 2, wherein ends of said trough extend out ward from the openings beyond the continuous sidewall of said tank.

7. The apparatus as recited in claim 1, wherein an outer perimeter dimension of said enclosed top is less than an outer perimeter dimension of said bottom.

8. The apparatus as recited in claim 1, further including a removable plug engaged with said fluid inlet.

9. The apparatus as recited in claim 1, wherein said fluid outlet includes a threaded orifice in the lower bottom portion of the tank and a drain coupled to said threaded orifice.

10. An animal watering apparatus comprising:
a tank having an enclosed top and bottom with a continuous sidewall interconnecting the top and bottom; a fluid inlet is formed in said enclosed top and a fluid outlet is formed in said enclosed bottom portion of said tank;
said continuous sidewall extending downward from said bottom of said tank beyond a perimeter of said enclosed bottom, said sidewall including two opposed openings extending through the sidewall below the enclosed bottom of the tank; and
a trough extending through the two opposed openings of said continuous sidewall, wherein said trough obstructs access into an interior region formed by said continuous sidewall through the openings of said continuous sidewalls.

11. The apparatus as recited in claim 10, further including a trough stop extending downward from said enclosed bottom.

12. The apparatus as recited in claim 10, wherein said trough slides through the openings of said continuous sidewall.

13. The apparatus as recited in claim 11, wherein said trough stop is positioned on said enclosed bottom proximate to a first one of said openings, wherein said trough slides through said first one of said openings and said trough stop restricts an end of said trough from sliding past said first one of said openings.

14. The apparatus as recited in claim 11, further including a removable plug engaged with said fluid inlet.

15. The apparatus as recited in claim 11, wherein said fluid outlet includes a threaded orifice in the lower bottom portion of the tank and a drain coupled to said threaded orifice.

16. An animal watering apparatus comprising:
a tank having an enclosed top and bottom with a continuous sidewall interconnecting the top and bottom; a fluid inlet is formed in said enclosed top and a fluid outlet is formed in said enclosed bottom portion of said tank;
a removable plug engaged with said fluid inlet;
said fluid outlet includes a drain;
said continuous sidewall extending downward from said bottom of said tank beyond a perimeter of said enclosed bottom, said sidewall including first and second opposed openings extending through the sidewall below the enclosed bottom of the tank; and
a trough extending through the two opposed openings of said continuous sidewall, wherein said trough obstructs access through said openings into an interior region formed by said continuous sidewall.

17. The apparatus as recited in claim 16, further including a trough stop extending downward from said enclosed bottom.

18. The apparatus as recited in claim 17, wherein said trough stop is positioned on said enclosed bottom proximate to said first opening, wherein said trough slides through said first openings and said trough stop restricts an end of said trough from sliding past said first openings.

19. The apparatus as recited in claim 11, further including a removable plug engaged with said fluid inlet.

20. The apparatus as recited in claim 11, wherein said fluid outlet includes a threaded orifice and said drain is coupled to said threaded orifice.
